(19) United States
(12) Patent Application Publication
(10) Pub. No.: US 2018/0198146 A1
(43) Pub. Date: Jul. 12, 2018

(54) MULTI-LAYER FUEL CELL ELECTRODES WITH DIFFERENT LOADINGS ON THE SUPPORTED CATALYSTS

(71) Applicants: Daimler AG, Stuttgart (DE); Ford Motor Company, Dearborn, MI (US); Nissan Motor Co., Ltd., Yokohama-shi, Kanagawa (JP)

(72) Inventors: Scott MCDERMID, Vancouver (CA); Harmeet CHHINA, Vancouver (CA); Dorina MANOLESCU, West Vancouver (CA)

(21) Appl. No.: 15/739,818

(22) PCT Filed: Jun. 23, 2016
(86) PCT No.: PCT/IB2016/000896

§ 371 Date: Dec. 26, 2017

Related U.S. Application Data
(60) Provisional application No. 62/191,259, filed on Jul. 10, 2015.

(51) Int. Cl. H01M 8/1004; H01M 4/92; H01M 4/90; H01M 4/86; H01M 4/88

(52) U.S. Cl. CPC H01M 8/1004; H01M 4/926; H01M 4/8803; H01M 4/8657; H01M 4/9083

(57) ABSTRACT

The performance of a solid polymer membrane electrolyte fuel cell under various operating conditions can be improved via use of electrodes comprising multiple layers of supported catalyst in which the layers comprise different catalyst loadings on their respective supports. Such an electrode comprises a first component catalyst layer adjacent the membrane electrolyte and a second component catalyst layer adjacent the first component layer. The loading of the catalyst in the first component layer is greater than that in the second component layer.

### BACKGROUND

### Field of the Invention

The present invention pertains to the catalyst layer structures for the electrodes used in solid polymer electrolyte fuel cells. In particular, the invention relates to multiple catalyst layer structures in which the layers comprise varied catalyst loadings on their respective supports.

### Description of the Related Art

Sustained research and development effort continues on fuel cells because of the energy efficiency and environmental benefits they can potentially provide. Solid polymer electrolyte fuel cells show particular potential for use as power supplies in traction applications, e.g. automotive. However, various challenges remain in obtaining desired performance and cost targets before fuel cells are widely adopted for automotive applications in particular. One such challenge is to achieve desired performance targets under all the varied operating conditions that can be experienced in typical automotive use.

Solid polymer electrolyte fuel cells electrochemically convert fuel (typically hydrogen) and oxidant (e.g. oxygen or air) to generate electric power. They generally employ a proton conducting polymer membrane electrolyte between two porous electrodes, namely a cathode and an anode. In operation, hydrogen is oxidized at the anode to create a hydrogen ion (proton) and an electron. The former is transported through the proton conducting polymer electrolyte to the cathode, while the latter is transported to the cathode through an external circuit thereby providing useful electrical power. At the cathode, oxygen is reduced and is combined with the proton and electron to create water. This reaction at the cathode is known as the oxygen reduction reaction. Appropriate catalyst compositions (typically supported platinum or platinum alloy compositions) are employed at each electrode to increase the reaction rate. The ability of the fuel cell to generate electrical power not only depends on how rapidly the oxygen reduction reaction can occur at the catalyst interface but also on how rapidly the reactants can be provided to the interface and how rapidly the by-product water can be removed therefrom. The mass transport properties of the cathode are those properties associated with moving the mass of reactants to and the mass of by-products from the cathode. Improving these mass transport properties can lead to improvements in the performance of the cathode.

Porous gas diffusion layers (GDLs) are usually employed adjacent the two electrodes to assist in diffusing the reactant gases evenly to the electrodes. Further, an anode flow field plate and a cathode flow field plate, each comprising numerous fluid distribution channels for the reactants, are provided adjacent the anode and cathode GDLs respectively to distribute reactants to the respective electrodes and to remove by-products of the electrochemical reactions taking place within the fuel cell. Water is the primary by-product in a cell operating on hydrogen and air reactants. Because the output voltage of a single cell is of order of 1V, a plurality of cells is usually stacked together in series for commercial applications. In such a stack, the anode flow field plate of one cell is thus adjacent to the cathode flow field plate of the adjacent cell. For assembly purposes, a set of anode flow field plates is often bonded to a corresponding set of cathode flow field plates prior to assembling the stack. A bonded pair of an anode and a cathode flow field plate is known as a bipolar plate assembly. Fuel cell stacks can be further connected in arrays of interconnected stacks in series and/or parallel for use in automotive applications and the like.

In the manufacture of solid polymer electrolyte fuel cells, the cathode and anode electrodes may be coated directly onto the polymer membrane electrolyte to create a structure known as a catalyst coated membrane (CCM). Alternatively, decal transfer methods may be employed to transfer an electrode, which had been previously coated on a substrate, to the membrane electrolyte. In a like manner, the cathode and anode electrodes may instead be coated directly onto the GDLs or decal transferred thereto. In the preparation of the cathode and anode electrodes, catalyst inks are typically prepared and then used to make such coatings. Such catalyst inks typically comprise the desired supported catalyst (e.g. carbon supported platinum powder), ionomer solution, optional additional electrically conductive particulates (e.g. carbon powder), pore forming additives, and suitable carrier solvents.

Researchers have experimented with numerous configurations and combinations of typical fuel cell components over the years in an attempt to improve cell performance. In particular, numerous variations in the structure of the catalyst electrodes have been investigated. As an example, in US20080292933 electrode structures comprising various combinations of a carbon supported catalyst layer and a metal catalyst layer (i.e. unsupported catalyst) were studied.

Although fuel cell performance can be acceptable over the numerous conditions faced in certain applications, there is still a general need for performance improvement. Further, a potentially acceptable approach can involve improving performance under certain operating conditions, even though it may involve a modest performance trade-off under other operating conditions. The present invention fulfills this and other needs and provides for such a potentially acceptable approach.

### SUMMARY

It has been found that the performance of a solid polymer membrane electrolyte fuel cell under various operating conditions can be improved by use of an electrode comprising multiple layers of supported catalyst in which the layers comprise different catalyst loadings on their respective supports.

Specifically, a solid polymer electrolyte fuel cell of the invention comprises a solid polymer membrane electrolyte, an anode adjacent one side of the membrane electrolyte and comprising an anode catalyst layer, a cathode adjacent the other side of the membrane electrolyte and comprising a cathode catalyst layer, and in which at least one of the anode catalyst layer and the cathode catalyst layer comprises multiple component layers of supported catalyst. The relevant catalyst layer (i.e. the at least one of the anode catalyst layer and the cathode catalyst layer) comprises a first component catalyst layer adjacent the membrane electrolyte in which the first component catalyst layer comprises a first supported catalyst with a first catalyst loading on the support. In addition, the relevant catalyst layer comprises a second component catalyst layer adjacent the first component catalyst layer in which the second component catalyst layer comprises a second supported catalyst with a second catalyst loading on the support. In the present invention, the first catalyst loading is greater than the second catalyst loading.

In an exemplary embodiment and as demonstrated in the Examples below, an unexpected performance improvement can be obtained when using such a multiple component layer construction for the cathode catalyst layer. It has been found that the first catalyst loading can be greater than 50% of the weight of the first supported catalyst. Further, the first catalyst loading can be about 70% of the weight of the first supported catalyst. With regards to the second catalyst loading, it can be less than 50% of the weight of the second supported catalyst. Further, the second catalyst loading can be about 30% of the weight of the second supported catalyst. And, the first catalyst loading can be greater than twice that of the second catalyst loading by weight.

The catalysts employed in the first and second supported catalysts may be the same or different substances and for instance may comprise platinum or alloys of platinum. Optionally, these catalysts may alternatively or additionally comprise alloys. The supports employed in the first and second supported catalysts may comprise carbon. In certain embodiments, the amount of catalyst in the first component layer may be about the same as the amount of catalyst in the second component catalyst layer. (This can be achieved for instance by incorporating a greater amount of the supported catalyst having the lower catalyst loading in its associated catalyst layer while incorporating a lesser amount of the other supported catalyst having the higher catalyst loading in its other associated catalyst layer.) As an example, the amount of catalyst in the first and second component layers may be about 0.25 mg Pt/cm².

While embodiments of the invention may comprises more than two component catalyst layers, a desirable embodiment includes a cathode catalyst layer which is a cathode catalyst bilayer consisting of the first and second component catalyst layers.

An electrode of the invention may comprise other useful materials commonly used in such cells. For instance, each of the first and second component layers may comprise perfluorosulfonic acid ionomer in which the weight ratio of the ionomer to the supports in each of the first and second supported catalysts is about 1.

The present invention includes both fuel cells and methods for making related fuel cells. Various options for making such fuel cells will be apparent to those skilled in the art. However, the methods commonly involve obtaining an appropriate first and second supported catalysts and then preparing the desired catalyst layer or layers (i.e. either the anode catalyst layer or the cathode catalyst layer or both) such that the first component catalyst layer adjacent the membrane electrolyte comprises the first supported catalyst, and the second component catalyst layer adjacent the first component catalyst layer comprises the second supported catalyst.

### BRIEF DESCRIPTION OF THE DRAWINGS

FIG. 1a compares polarization plots of an inventive cell and several comparative cells operating under “Normal” operating conditions from the Examples.

FIG. 1b compares the cell voltages @ 1.9 A/cm² versus number of accelerated stress test cycles of an inventive cell and several comparative cells operating under “Normal” operating conditions from the Examples.

FIG. 2a compares polarization plots of an inventive cell and several comparative cells operating under “Hot and Dry” operating conditions from the Examples.

FIG. 2b compares the cell voltages @ 1.5 A/cm² versus number of accelerated stress test cycles of an inventive cell and several comparative cells operating under “Hot and Dry” operating conditions from the Examples.

FIG. 3 compares polarization plots of an inventive cell and several comparative cells operating under “Cool and Dry” operating conditions from the Examples.

### DETAILED DESCRIPTION

Herein, in a quantitative context, the term “about” should be construed as being in the range up to plus 10% and down to minus 10%.

The term “multiple” means more than one (i.e. two or more).

The plain meaning of the term “catalyst” is used herein to refer to a substance which increases the rate of a chemical reaction without itself being affected. In particular herein, “catalyst” refers to those substances serving as an oxygen evolution catalyst and/or a hydrogen reduction catalyst

The term “supported catalyst” refers to a composition comprising a “catalyst” as defined above and a support material, in which the support material differs from the catalyst substance, and in which the catalyst has been deposited or dispersed on the support material.

With regards to supported catalysts, the term “catalyst loading on the support” refers to the amount of catalyst on a given amount of supported catalyst (e.g. % by weight of catalyst present on a given weight of supported catalyst). A supported catalyst as defined herein thus may have a catalyst loading on the support between 0% and 100%, but not equal to 0% or to 100%.

With regards to a catalyst layer, “the total catalyst loading in the layer” refers to the amount of catalyst present in a given amount of catalyst layer (e.g. % by weight of catalyst present in a given weight of catalyst layer).

In a like manner, with regards to an electrode, “the total catalyst loading in the electrode” refers to the amount of catalyst present in a given amount of electrode which may comprise more than one catalyst layer.

The present invention relates to solid polymer electrolyte fuel cells and stacks in which multi-layer electrodes are employed. The layers in the multi-layer electrodes comprise supported catalysts in which the catalyst loadings on the supports vary such that the catalyst loading in the layer adjacent the solid polymer membrane electrolyte is greater than the catalyst loading in the adjacent layer in the electrode. Use of such multi-layer electrodes can improve cell performance under various operating conditions. With the exception of the inventive multi-layer electrode structures, the construction of the fuel cells, and stacks thereof, can be any of the conventional constructions known to those in the art.

The multi-layer electrodes comprise two or more component catalyst layers with different compositions. In an assembled fuel cell of the invention, a first component catalyst layer in the multi-layer electrode would be located adjacent the membrane electrolyte. A second component catalyst layer would be located adjacent the first component catalyst layer on the side opposite the membrane electrolyte. Both first and second component catalyst layers in the electrode contain a suitable supported catalyst. The catalyst employed in each of the first and second component catalyst layers can be the same or different substances. Numerous options for use as catalyst in such fuel cells are known in the art. Noble metal compositions such as platinum, platinum alloys, and/or mixtures are commonly used in the art. Numerous options for use as supports in such fuel cells are also known in the art. Commonly, the supports are high surface area carbon powders (e.g. amorphous carbon powders having BET surface areas greater than about 50 m²/g, and particularly greater than about 300 m²/g).

In exemplary embodiments, platinum catalyst may be employed in both the first and second component layers. Typically, in the case of platinum catalyst, loading amounts in the range from about 20 to 70% by weight are considered to be manufacturable and hence may be considered in practice. (Loading amounts substantially greater than 70% would likely result in decreased performance because such a layer would increasingly obstruct mass transport. A pure platinum black layer for instance is harder to process into a homogenous layer. Conversely, having adequate carbon present helps processing, layer homogeneity, and ensures good electrical connectivity.) The total platinum loading in the prepared electrode may desirably be in the range from 0.1 to 0.5 mg/cm² (e.g. about 0.25 mg/cm²). The component catalyst layers typically also include perfluorosulfonic acid ionomer and optionally other components (e.g. conductive fillers, additives to modify hydrophobicity, etc.). In an exemplary embodiment, the weight ratio of the ionomer to that of the carbon powder support can be about 1 in a layer, and the equivalent weight of the ionomer employed can be about 825. However, a wide range of weight ratios of ionomer to carbon powder support may be contemplated. And numerous options for the ionomer type and equivalent weight may be considered.

In the inventive structure, the catalyst loading on the supports in the first component catalyst layer is greater than the catalyst loading on the supports in the second component catalyst layer.

Notwithstanding this, the total catalyst loading in the first component catalyst layer as a whole may be the same as, or in principle even less than, the total catalyst loading in the second component catalyst layer. In addition, the total catalyst loading in the complete electrode may be the same as, or in principle different from, those loadings typically used in conventional fuel cell electrodes.

In exemplary embodiments, the catalyst loading on the supports in the first component catalyst layer (e.g. 70% by weight) is significantly greater than the catalyst loading on the supports in the second component catalyst layer (e.g. 30% by weight). The total catalyst loadings in each of the two component layers however can be the same. As illustrated in the Examples below, this can result in substantial performance improvements under many operating conditions. However, other loading amounts in the individual layers can be considered (e.g. the total catalyst loading in the first component layer may be substantially greater than that in the second component layer or vice versa).

Multi-layer electrodes of the invention can be prepared in various ways known to those skilled in the art. As an example, decal transfer methods may be employed. In such methods, a suitable catalyst ink is applied using screen printing or Mayer rod techniques to a transfer medium and the ink is dried to create a catalyst layer on the transfer medium. For these multiple layer embodiments, this process may simply be repeated using the desired catalyst inks in an appropriate sequence. The transfer medium with applied catalyst layers is then contacted with a desired membrane electrolyte and the multi-layer catalyst electrode is then decal transferred to the membrane by applying suitable heat and pressure. In other examples though, spray coating techniques may be used. Further, the coatings may be applied directly to the membrane electrolyte. And further still, the multi-layer electrode may be applied to a gas diffusion layer instead of the membrane.

As illustrated in the Examples below, use of the inventive multi-layer catalyst electrodes in solid polymer electrolyte fuel cells, and particularly at the cathodes, can result in significant performance improvements under a variety of operating conditions. Without being bound by theory, it is believed that the high concentration of platinum near the membrane and an increasing porosity gradient toward the gas diffusion layer provides a structure that balances proton conductivity and gas access requirements for the catalyst layer. This in turn should improve catalyst layer function and increase cell performance. Such an approach may provide benefits at both the anode and the cathode due to enhanced gas and water transport.

The following Examples have been included to illustrate certain aspects of the invention but should not be construed as limiting in any way.

### EXAMPLES

In the following, supplies of conventional carbon supported catalyst were obtained and portions were dry milled in accordance with the method of the invention. And experimental fuel cells were made using these catalyst compositions and the performance results under various operating conditions were obtained and compared.

In these Examples, three types of commercially available carbon supported catalyst powders were employed. The carbon supports in all three were similar high surface area amorphous carbons. One type, denoted “50%”, nominally comprised 50% by weight platinum catalyst highly dispersed over the carbon support surface. A second type, denoted “30%”, nominally comprised 30% by weight platinum catalyst highly dispersed over the carbon support surface. A third type, denoted “70%”, nominally comprised 70% by weight platinum catalyst highly dispersed over the carbon support surface.

A series of experimental fuel cells were made using these various catalyst powders in several different cathode electrode variations. The membrane electrolyte used in each cell was made of perfluorosulfonic acid ionomer that was about 15-20 micrometer thick. In all cases, catalyst layers were decal transferred onto opposite sides of the membrane to form the anode and cathode electrodes. In decal transfer, a suitable catalyst ink was first applied to a transfer medium and dried to create a catalyst layer on the transfer medium. In cases where multiple layers were involved, the process was repeated using the desired catalyst inks in an appropriate sequence. The transfer medium with applied catalyst layer was then contacted with the membrane and the catalyst layer or layers were decal transferred thereto via the application of heat and pressure. Catalyst inks for these coatings were prepared by mixing about 50 wt % of a specific carbon supported with about 20 wt % 825 EW (equivalent weight) ionomer solution, 1-propanol and distilled water resulting in a nominal ionomer to carbon weight ratio of one. The inks were jarmilled (wet) for a set period of time. The inks were then coated onto Teflon film using a Mayer rod and dried at about 60 to 80° C. for a few hours. Bilayer structures were obtained by sequential coatings of the two catalyst inks.

The anode catalyst in each cell was a conventional commercial carbon supported platinum (Pt/C) product comprising about 46% Pt by weight and the anode layer comprised about 0.05 to 0.1 mg/cm² of Pt. Each cathode combination comprised the same total Pt loading of about 0.25 mg/cm². Further, the weight ratio of ionomer to that of the carbon powder in the catalyst supports in each combination was about 1. However, several different catalyst layer combinations were used for the cathodes in these cells. A combination for use in a comparative cell comprised a single layer of 50% catalyst. A combination for use in another comparative cell comprised a single layer of a mix of 30% and 70% catalysts in which equal portions of the two catalysts were used by weight of Pt. Another combination for a comparative cell comprised two layers in which the first layer adjacent the membrane electrolyte solely comprised 30% catalyst and the second layer solely comprised 70% catalyst. The amounts were adjusted such that the weight of Pt in each layer was the same. Finally, a combination for an inventive cell comprised two layers in which the layers were reversed, namely the first layer adjacent the membrane electrolyte solely comprised 70% catalyst this time and the second layer solely comprised 30% catalyst. Again, the amounts were adjusted such that the weight of Pt in each layer was the same. In the following, the comparative cells comprising these different cathode catalyst layer combinations are denoted “50% single layer”, “30%+70% single layer”, and “30%/70% double layer” respectively. The inventive cell is denoted “70%/30% double layer”.

To finish fabricating individual experimental fuel cells, the preceding catalyst coated membranes (CCMs) were sandwiched between anode and cathode gas diffusion layers (GDLs) comprising commercial carbon fibre paper from Freudenberg. Assemblies comprising the appropriate CCMs and anode and cathode GDLs were then bonded together under elevated temperature and pressure and placed between appropriate cathode and anode flow field plates having straight flow field channels in order to complete the experimental fuel cell constructions.

These fuel cells were first conditioned by operating at a current density of 1.0 A/cm², with hydrogen and air as the supplied reactants at high stoichiometries and at 100% relative humidity (RH), and at a temperature of about 70° C. overnight. Then, the performance characteristics of the fuel cells were obtained by measuring output voltage as a function of current density under a variety of operating conditions that would typically be experienced in automotive applications. In certain cases, the fuel cells were also subjected to accelerated stress testing which focused primarily on cathode catalyst layer degradation over time. This involved subjecting the fuel cell to voltage cycling between 0.1 and 1.0 volts using a square wave cycle of 2 sec and 2 sec duration respectively. After every 5000 cycles, cell performance was again evaluated by obtaining polarization curves as before. Representative results are shown in the following figures.

The operating conditions involved in this Example are summarized below and include:
Normal: 68° C., 70% RH
Hot and Dry: 85° C., 45% RH
Cool and Dry: 40° C., 50% RH

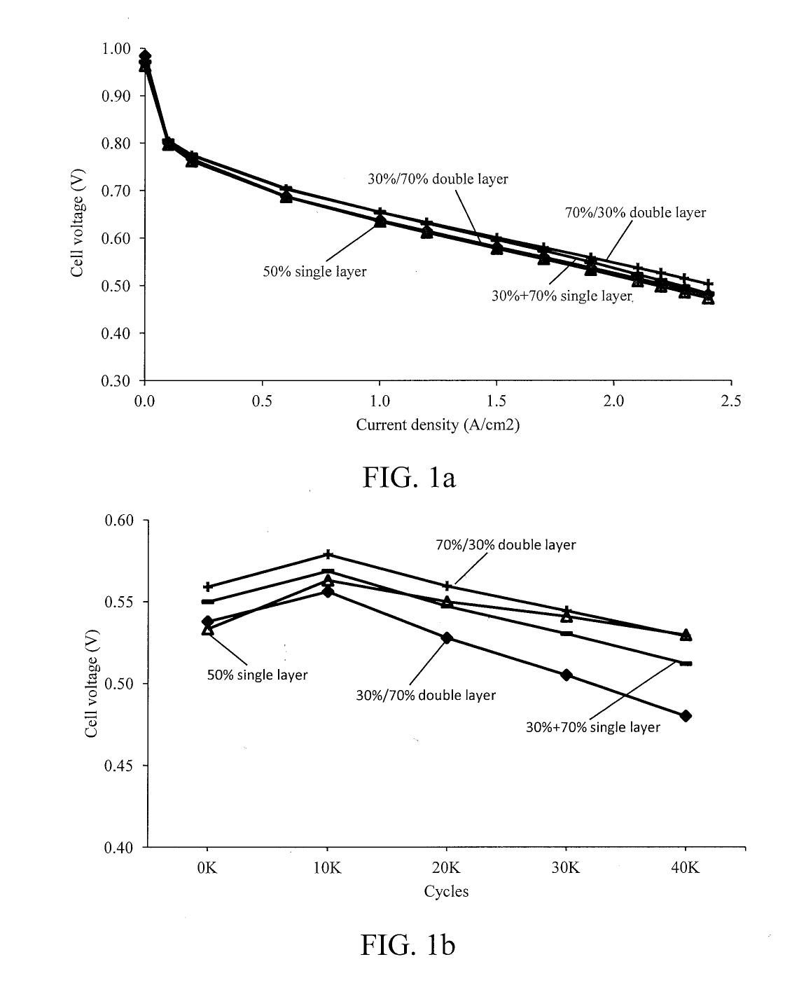

FIG. 1a compares the polarization plots (voltage versus current density from 0 to over 2 A/cm²) of the inventive 70%/30% double layer cell to all the comparative cells operating under Normal operating conditions. The inventive 70%/30% double layer cell performed as well or better than all the comparative cells. Stress testing was then carried on all the cells under “Normal” operating conditions. FIG. 1b compares the cell voltages @ 1.9 A/cm² versus number of accelerated stress test cycles under the “Normal” operating conditions. The inventive 70%/30% double layer cell showed significantly better results under stress testing than all the comparative cells. The comparative 30%/70% double layer cell on the other hand showed significantly worse results than all the other cells.

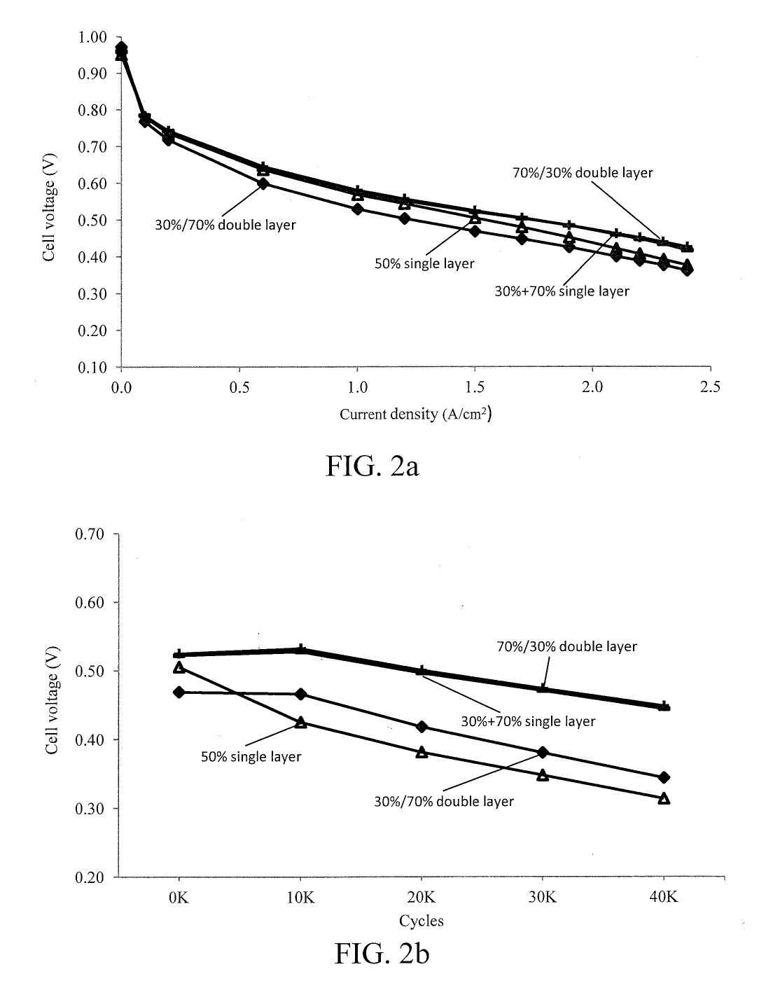

In a like manner to FIG. 1a, FIG. 2a compares polarization plots of all the cells, but operating under “Hot and Dry” operating conditions. Again, the inventive 70%/30% double layer cell performed as well as the comparative 30%+70% single layer cell, and performed significantly better than both the more conventional 50% single layer and the comparative 30%/70% double layer cells. Stress testing was then carried on all the cells under “Hot and Dry” operating conditions. FIG. 2b compares the cell voltages (@ 1.5 A/cm² in this case) versus number under the “Hot and Dry” operating conditions. Again, the inventive 70%/30% double layer cell showed significantly better results under stress testing here than all the comparative cells.

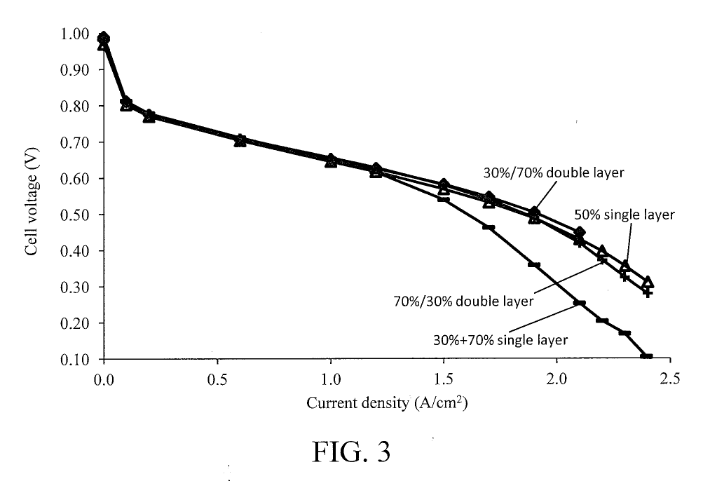

FIG. 3 compares polarization plots of all the cells, but this time operating under “Cool and Dry” operating conditions. Again, the inventive 70%/30% double layer cell performed as well or better than all the comparative cells. Interestingly, the 30%+70% single layer cell performed significantly worse than all the others.

Table 1 below compares the observed output voltages of all the fuel cells @ 1.9 A/cm² when operating under “Hot and Dry” operating conditions. Once again, the inventive 70%/30% double layer cell showed the best performance. The comparative 30%/70% double layer cell on the other hand showed the worst results.

TABLE 1

| Fuel cell | Cell voltage @ 1.9 A/cm² |
|---|---|
| 50% single layer | 0.452 |
| 30% + 70% single layer | 0.484 |
| 30%/70% double layer | 0.425 |
| 70%/30% double layer | 0.485 |

The preceding Examples thus demonstrate that superior results are obtained with the inventive double layer cell under many different operating conditions, and that results at least as good as the other cells under all operating conditions.

All of the above U.S. patents, U.S. patent application publications, U.S. patent applications, foreign patents, foreign patent applications and non-patent publications referred to in this specification, are incorporated herein by reference in their entirety.

While particular elements, embodiments and applications of the present invention have been shown and described, it will be understood, of course, that the invention is not limited thereto since modifications may be made by those skilled in the art without departing from the spirit and scope of the present disclosure, particularly in light of the foregoing teachings. For instance, the invention is not limited just to fuel cells operating on pure hydrogen fuel but also to fuel cells operating on any hydrogen containing fuel or fuels containing hydrogen and different contaminants, such as reformate which contains CO and methanol. Such modifications are to be considered within the purview and scope of the claims appended hereto.

What is claimed is:

1. A solid polymer electrolyte fuel cell comprising a solid polymer membrane electrolyte, an anode adjacent one side of the membrane electrolyte and comprising an anode catalyst layer, a cathode adjacent the other side of the membrane electrolyte and comprising a cathode catalyst layer, wherein at least one of the anode catalyst layer and the cathode catalyst layer comprises:
a first component catalyst layer adjacent the membrane electrolyte wherein the first component catalyst layer comprises a first supported catalyst with a first catalyst loading on the support; and
a second component catalyst layer adjacent the first component catalyst layer wherein the second component catalyst layer comprises a second supported catalyst with a second catalyst loading on the support;
wherein the first catalyst loading is greater than the second catalyst loading.

2. The fuel cell of claim 1 wherein the cathode catalyst layer comprises:
a first component catalyst layer adjacent the membrane electrolyte wherein the first component catalyst layer comprises a first supported catalyst with a first catalyst loading on the support; and
a second component catalyst layer adjacent the first component catalyst layer wherein the second component catalyst layer comprises a second supported catalyst with a second catalyst loading on the support;
wherein the first catalyst loading is greater than the second catalyst loading

3. The fuel cell of claim 1 wherein the first catalyst loading is greater than 50% of the weight of the first supported catalyst.

4. The fuel cell of claim 3 wherein the first catalyst loading is about 70% of the weight of the first supported catalyst.

5. The fuel cell of claim 1 wherein the second catalyst loading is less than 50% of the weight of the second supported catalyst.

6. The fuel cell of claim 5 wherein the second catalyst loading is about 30% of the weight of the second supported catalyst.

7. The fuel cell of claim 1 wherein the first catalyst loading is greater than twice that of the second catalyst loading by weight.

8. The fuel cell of claim 1 wherein the catalysts in the first and second supported catalysts comprise platinum.

9. The fuel cell of claim 1 wherein the supports in the first and second supported catalysts comprise carbon.

10. The fuel cell of claim 1 wherein the amount of catalyst in the first component layer is about the same as the amount of catalyst in the second component catalyst layer.

11. The fuel cell of claim 10 wherein the catalysts in the first and second supported catalysts comprise platinum and the amount of catalyst in the first and second component layers is about 0.25 mg Pt/cm².

12. The fuel cell of claim 2 wherein the cathode catalyst layer is a cathode catalyst bilayer consisting of the first and second component catalyst layers.

13. The fuel cell of claim 2 wherein each of the first and second component layers comprise perfluorosulfonic acid ionomer and wherein the weight ratio of the ionomer to the supports in each of the first and second supported catalysts is about 1.

14. A method for making the fuel cell of claim 1 comprising:
obtaining the first supported catalyst with the first catalyst loading on the support;
obtaining the second supported catalyst with the second catalyst loading on the support wherein the first catalyst loading is greater than the second catalyst loading; and
preparing the at least one of the anode catalyst layer and the cathode catalyst layer such that the first component catalyst layer adjacent the membrane electrolyte comprises the first supported catalyst, and the second component catalyst layer adjacent the first component catalyst layer comprises the second supported catalyst.
